(19) United States
(12) Patent Application Publication
(10) Pub. No.: US 2004/0020277 A1
(43) Pub. Date: Feb. 5, 2004

(54) Monitoring erosion of ceramic insulation or shield with wide area pneumatic grids

(76) Inventors: Gordon Bryce McGarvey, Canadian (CA); Lorne G. Powell, Canadian (CA); Brian J. Savidant, Canadian (CA)

Correspondence Address: ExxonMobil Research and, Engineering Company, P. O. Box 900, Annandale, NJ, 08801-0900, US

(21) Appl. No.: 10/209,123

(22) Filed: Jul. 31, 2002

(51) Int. Cl. G01N 17/00

(52) U.S. Cl. 73/86

(57) ABSTRACT

Detecting erosion of refractory thermal insulation or a ceramic shield over a wide area is achieved by monitoring the gas pressure in at least one wide area planar grid, in or under the insulation or shield and parallel to its hot or impact face. The plane of the grid follows that of the hot or impact face of the shield. The grid is fabricated from one or more hollow conduits in fluid communication and a single fluid conduit connects it to a pressure detector. Using a plurality of grids at different distances from the hot or impact face enables monitoring erosion over time. This enables wide area coverage as much or more than eight square feet in, e.g., a coker, without unduly impairing the integrity of the vessel wall and eliminates the danger of sparks associated with electrical means.

### BACKGROUND OF THE DISCLOSURE

1. Field of the Invention

The invention relates to wide area detection and monitoring of the erosion of a ceramic shield or insulation exposed to a hot environment, using wide area pneumatic grids. More particularly the invention relates to detecting and monitoring the erosion of a ceramic shield or thermal insulation over a wide area in a hot process vessel, with at least one wide area pneumatic grid which comprises a hollow fluid conduit containing a gas under a predetermined pressure and which substantially follows the contour of the hot or impact face of the insulation or shield in or under which it is disposed.

2. Background of the Invention

Most furnaces and many chemical process vessels, such as coker scrubbers, high temperature chemical reactors, vessels containing molten metal and the like, contain thermal insulating material disposed against, or proximate to, at least a portion of the interior surface of the vessel, in which the combustion, reaction or other process occurs. The thermal insulating material is typically fabricated of refractory metal oxide ceramic and prevents creeping, softening, melting and/or rapid erosion of the vessel wall, which is typically made of steel. Erosion of the insulation typically occurs as a result of one or more fluid streams flowing in the vessel and proceeds much more rapidly if the flowing stream contains solid particulate matter, such as particles of coke, catalyst, combustion ash and the like. Monitoring the erosion is necessary to protect the steel wall of the vessel from being eroded and breached. Erosion detecting and monitoring devices typically comprise a plurality of separate and discrete electrical wires or closed end gas conduits, imbedded in the insulation. The longitudinal axes of the conduits and wires are typically aligned in a direction radially and/or perpendicularly disposed from the interior surface of the vessel wall, inwardly towards the interior of the vessel. When the insulation or shield is eroded down to the wire or the gas conduit, it quickly cuts the wire or makes a hole in the conduit. This produces an open circuit or change in pressure, which is detected and causes a signal to be sent to an alarm or control panel, indicating that insulation erosion has reached that point. This enables an operator or computer to change the operating conditions of the unit to reduce the erosion rate or to schedule a shutdown for repair of the insulation, before catastrophic erosion or melting through the vessel wall can occur.

U.S. Pat. Nos. 3,898,366; 4,248,809; 4,442,706; 5,566,626 5,571,955 and 5,740,861 disclose typical methods and means used for monitoring erosion of a shield or insulation lining the interior of a hot process vessel. These patents disclose a plurality of probes having their longitudinal axis radially aligned and perpendicular to the longitudinal axis of the vessel, or to the plane of a particular part of the vessel wall. Only a relatively small cross-sectional area of the insulation parallel to the inner wall surface of the vessel is monitored by each probe and erosion must occur uniformly across the insulation where the probes are placed, for the monitoring to be effective. The small monitoring area limitation of each probe requires a plurality of probes to cover a wide area, at a given depth in the insulation. Each probe must have associated with it (i) means for detecting a change in pressure, current, resistance, etc., and (ii) means for sending a signal indicative of such change to (iii) means for indicating and recording the change, and insuring that any required action be taken as a consequence of the detected erosion. Each probe in the vessel is typically connected, through a hole in the exterior wall of the vessel, to a hermetically sealed packing gland known as a nozzle, and then to signal and recording means outside the vessel. If the pressure in the vessel is different from ambient, the nozzle must include at least one pressure barrier. The nozzle is attached to the outer surface of the vessel wall over the hole and, for a hot vessel, must also be resistant to high temperature. In addition to cost, each nozzle requires a significant amount of space on the exterior vessel wall surface. Each hole compromises the integrity of the wall. The space requirements for the nozzles and the danger to the integrity of the vessel wall integrity limit the number of probes that can be used. Therefore, it would be an improvement if erosion monitoring could be achieved over a relatively wide area, particularly when particulate erosion is a factor, such as between a coker nozzle and vessel wall, with fewer connections through the wall.

### SUMMARY OF THE INVENTION

The invention relates to monitoring the pressure in at least one wide area pneumatic grid, for detecting erosion and monitoring the erosion rate over a wide area of a refractory ceramic shield or thermal insulation. In the process of the invention, the shield or insulation will typically be in a hot environment such as, for example, a furnace, reactor or other process vessel. More particularly the invention relates to a method for detecting and monitoring erosion of a ceramic shield or thermal insulation over a wide area in a vessel, by monitoring the pressure in at least one relatively planar, wide area pneumatic grid, the plane of which substantially follows the contour of the surface of the insulation or shield in or under which it is disposed, that is subject to erosion and wherein the grid comprises a hollow fluid conduit containing a fluid and preferably a gas, under a predetermined pressure. When erosion reaches the grid, it erodes a hole in it and the pressure of the fluid in it changes. The change in grid pressure indicates that erosion has progressed through the shield or insulation to where the grid is located. The term “grid” as used herein is employed in its ordinary sense and refers to a plurality of substantially parallel sections of conduit arrayed in the plane of the grid, as is explained in detail below. In a preferred embodiment, a single conduit, in fluid communication with the grid, extends from the grid to means for detecting the change in grid pressure. In an embodiment in which the shield or insulation is in a closed environment, such as in a vessel, the single conduit extends from the grid to or through a hole in the vessel and preferably to a nozzle exterior of the vessel, where connection is made to a conduit or wire in or external of the nozzle, to means for detecting a change in the pressure of the gas in the grid. The means for detecting changes in the grid pressure preferably causes a signal indicative of the pressure change to be sent to means exterior of the vessel, for recording the change and/or insuring that any required action be taken, as a consequence. By wide area is meant an area of at least one, preferably at least two and more preferably at least four square feet. The method of the invention is of particular use where fire or explosion is a concern.

The grid is typically disposed in the insulation or shield at a predetermined depth and along a plane substantially parallel to the plane of that surface of the insulation or shield subject to erosion. For thermal insulation this surface is called the hot face. For a thermal erosion shield it is referred to as the impact face. More precise erosion monitoring is possible by using more than one or grid, each located at a different distance from the hot or impact face. As the erosion reaches each grid, it erodes a hole in the conduit from which the grid is formed and the pressure in it changes. This change is detected and indicates that erosion has progressed to the location of the grid. The grid is fabricated from one or more conduits in fluid communication, each of which may simply be a hollow pipe or tube, fabricated to form a series of more or less parallel sections arrayed in a plane of substantially the same shape as that of the hot or impact face of the insulation or shield in which it is embedded or under which it is disposed. For a typical vessel, this plane will be arcuate, such as surface of a cylinder or sphere, but in some cases it may be flat. Both the shield and thermal insulation are ceramic, in that they comprise one or more refractory metal oxides, carbides, phosphates, carbonates, etc., which is relatively hard, brittle and resistant to high temperatures. By metal in this sense is meant to include silicon. They may also be cementatious, in that they may be formed from an aggregate mix, which contains water and is at least partially cured at ambient or slightly elevated temperature, much like ordinary cement and concrete. The term “shield” as used herein is meant to refer to one or more thermally insulating bodies of a limited size which protect only that part of the interior vessel wall subject to erosion. A shield contains one or more grids disposed within or under it at the surface not subject to erosion. One or more shields are disposed in the vessel at one or more particular locations subject to impact erosion, as opposed to thermal insulation, which is typically disposed more or less over the entire inner wall surface of at least a portion of the vessel.

In one embodiment, the invention relates to a method for detecting erosion of a ceramic shield or thermal insulation having an impact or hot face exposed to a hot environment, by monitoring the pressure in at least one relatively planar, wide area erosion detecting grid, the plane of which extends over an area of at least one square foot and substantially follows the contour of the impact or hot face of said shield or insulation in or under which it is disposed, that is subject to erosion, wherein the grid comprises at least one hollow fluid conduit in which a fluid is maintained at a predetermined pressure, until erosion reaches the grid and erodes an opening in it, which changes the pressure, and wherein the pressure change is detected. In another embodiment the invention relates to a method for detecting and monitoring the erosion of a ceramic shield or thermal insulation having an impact or hot face exposed to a hot environment and in which is disposed at least two, relatively planar, wide area pneumatic erosion detecting grids, the planes of which are substantially parallel, extend over an area of at least one square foot and substantially follow the contour of the impact or hot face where it is subject to erosion, with the grids being spaced apart and located at successively greater distances from the hot or impact face, by monitoring the pressure in each of the grids, wherein each grid comprises at least one hollow fluid conduit in which a fluid is maintained at a predetermined pressure, until erosion reaches each it and erodes an opening in it, which changes the pressure, and wherein the pressure change is detected.

### BRIEF DESCRIPTION OF THE DRAWINGS

FIGS 1(a), 1(b) and 1(c) are respective simple schematic partial cross-sectional front, side and top views of an embodiment of the invention.

FIG. 2 is a brief schematic illustrating grid conduits passing through a vessel wall nozzle assembly.

FIG. 3 schematically illustrates a grid conduit terminating in a pressure transducer.

FIG. 4 illustrates another embodiment of a grid conduit, gas supply and pressure transducer.

FIG. 5 is a brief schematic cross-section of a coker vessel.

FIG. 6 illustrates a cyclone discharge nozzle and an erosion shield containing grids according to the invention.

FIGS. 7(a) and 7(b) briefly illustrate two embodiments of an erosion shield containing grids according to the invention.

### DETAILED DESCRIPTION

With respect to erosion resulting from impingement of a mixture of fluid (e.g., gas or liquid) and particulate matter, it is known that the conduits, nozzles, gas jets and orifices which feed such fluid streams into furnaces, reaction vessels and other process vessels can and do develop problems (e.g., localized blockage, uneven wear, etc.), that result in a nonuniform stream of the gas and particle mixture being directed onto the insulation or shield. This results in nonuniform erosion and it is not possible to predict where such localized impingement and concomitant erosion will occur. Localized erosion from particulate matter can occur in coker scrubbers, fluidized catalytic processes, burners, furnaces which generate fly ash and the like. The use of small area, or spot probes in such installations is not acceptable, since it is not known, a'priori, where localized erosion will occur and there is therefore a need for a wide area erosion monitoring means for these applications. For example, in a coker the bottom coking section and the upper scrubbing section are connected by cyclones. Hot vapors and particulate matter from the coker section pass up through the cyclones. Each cyclone has a discharge nozzle, which discharges the hot vapors and particulate matter into the scrubbing section. A shield is disposed between the discharge nozzles and the vessel wall, to protect the wall from direct impingement and concomitant erosion by the particles. Thus, while there may be no need for thermal insulation over the interior surface of the vessel wall in the scrubber section, there is a need for a heat and erosion resistant ceramic shield between the vessel wall and the cyclone discharge nozzles.

By wide area is meant that each of the one or more grid extends over a planar area, which is preferably substantially parallel to the hot or impact face of the shield or insulation, of at least one, preferably at least two, more preferably at least four, and still more preferably at least about eight square feet. The shape of the grid may be square, oval, circular, or any other suitable polygonal or curvilinear shape, or combination thereof. While a grid comprising parallel sections of a tube or other conduit form arrayed in the grid plane is mentioned above, if desired, a single grid may also comprise two such parallel arrays. Such a grid may also be fabricated somewhat like a wire mesh screen, in which there are two parallel arrays, which may or may not be interlaced with each other, and in which the longitudinal axes of the conduits in one array are aligned perpendicular to the other. A pneumatic or gas-containing grid of the invention may be fabricated from a hollow, typically metal conduit (e.g., soft stainless steel) or from any other material softer than the thermal insulation and able to withstand the elevated temperature it will be subjected to, inside the insulation or shield in the vessel, without melting. This grid must also be gas or fluid impervious and able to maintain the desired pressure until erosion progressing through the insulation reaches it and erodes a hole in it. The grid may be fabricated from a single conduit or from a plurality of straight, angled and or curvilinear sections of conduit welded together, or otherwise attached so as to be gas impervious.

The cross-section of the conduit or conduits from which the grid is fabricated need not be circular. In some cases the cross-section of the conduit, if not circular may be square, elliptical or rectangular, with the major cross-sectional dimension substantially parallel to the plane of the grid and, concomitantly, the hot or impact face of the respective insulation or shield. This maximizes the overall grid surface parallel to the hot or impact face and perpendicular to the direction of the erosion, thereby maximizing the effectiveness and area coverage of the grid. The pressure maintained in each grid is different from the pressure in the vessel and will typically, but not necessarily, be greater than that in the vessel. In most applications a plurality of substantially similar grids will be disposed in the insulation parallel to each other and to the hot or impact face, with each located at a different distance between the hot or impact face of the insulation and the interior vessel wall, so that the progress of the insulation erosion is determined over a period of time. While the fluid in the grid may be liquid or gas, it will typically be a gas. When a gas is used, the grid may be referred to as a pneumatic grid. Preferably only a single conduit depends from each grid, with which it is in fluid communication, and extends to or through the exterior wall of the vessel. This conduit is connected, typically via a suitable thermally insulated and sealed nozzle exterior of the vessel, to means which detects a change in the fluid pressure. The pressure sensing means for each grid may be a simple pressure transducer or any other suitable means, for generating an electrical signal in the form of a voltage or current (e.g., P/I or P/V) indicative of the pressure in the grid. The signal actuates one or more of an alarm, computer, recording, chart, etc..

The invention enables wide area erosion coverage and the use of two or more grids, each at a different distance, from the hot or impact face, in the insulation or shield and having only one respective conduit extending through the vessel wall. This enables monitoring erosion across a relatively large area of the insulation or ceramic erosion shield, with relatively few conduits extending through the vessel wall. For example, four one-inch diameter conduits require about a six inch diameter hole through the vessel wall, due to thermal insulation requirements around each section of conduit. By using four separate grids of the invention, erosion can be monitored over a hot or impact face area of even greater than eight square feet, at four different depths in the insulation, with only one six inch hole in the vessel wall and only a single nozzle required. A hole greater than six inches in diameter is typically not recommended, because it compromises the integrity of the vessel wall and requires more nozzle space adjacent to the exterior vessel surface. A nozzle for a six inch diameter hole and four one inch conduits will take up an area of about one square foot adjacent to and exterior of the vessel. This is to accommodate isolation and bleed valves, expansion loops, sealing flanges, electrical connections, pressure detection connections and the like. To monitor erosion over an area of at least four square feet using the prior art arrangement, at least about thirty-six separate prior art conduit erosion probes arranged perpendicular to the hot face, are needed. Unlike the monitoring grids of the invention, this prior art arrangement will also be limited to a single depth in the insulation. Thus, nine separate and spaced apart sets of holes, nozzles, seals, valves, etc. are needed for the thirty-six erosion probes of the prior art pneumatic erosion monitoring means. The large number of holes and nozzles impairs the integrity of the vessel wall, requires maintenance of none nozzles, nine sets of nozzle valves, etc., and is costly. Thirty-six prior art erosion probes fabricated from one inch diameter metal tubing offer a metal conduit surface, parallel to the surface of the insulation, of only about 0.2 square feet. In contrast, if each grid of the invention comprised only six parallel lengths of one inch diameter tubing, each four feet long and laterally spaced apart by the same nine inches of the prior art probes, the metal conduit surface parallel to the hot face will be two square feet. Further, the spacing between the grid conduits of the invention may be made substantially less, without requiring more than one conduit one inch in diameter passing through the wall.

Reactors, furnaces, crucibles and other hot process vessels are made of metal, which is typically steel or a steel alloy. The interior vessel wall or that portion thereof exposed to high temperature is lined with thermal insulation, to insulate the metal wall from temperatures high enough to soften or melt it. The insulation typically takes the form of one or more layers of cast, sprayed, bricked or preformed insulation, fastened to the vessel wall by means of metal anchors attached to the wall and extending into the insulation. The insulation itself is relatively hard, brittle and resistant to high temperatures, typically comprising a somewhat porous aggregate of refractory metal oxides, carbides, phosphates, carbonates, etc., of metals such as magnesium, silicon, calcium, aluminum and compounds such as calcium aluminate which comprise more than one metal. Calcium aluminates and phosphates are widely used as the cement for aggregate insulation, particularly if it is formed by spraying or casting. As mentioned above, the inner surface of the insulation is exposed to the heat in the vessel's interior and is referred to as the “hot face”. It must be resistant to thermal degradation at the process conditions in the vessel. Some aggregates have good thermal insulating properties, but are not resistant to thermal degradation at very high temperatures, such as those in synthesis gas reformers, high temperature furnaces and the like. Where insulation comprising a composite of more than one layer is used, the hot face layer is typically the most resistant to thermal degradation, while the one or more underlayers are more thermally insulating, but not as thermally resistant. In such cases one or more grids are typically be positioned behind the hot or impact face layer and in the one or more softer, more thermally insulating layers not directly exposed to the hot impact conditions. In the case of vessels in which particulate erosion occurs, the hot face must be resistant to particulate and thermal erosion. This is also the case for ceramic shields, which protect a portion of the vessel wall or other structure in the vessel from particulate erosion. Ceramics having resistance to both particulate erosion and high temperature degradation are dense, hard, expensive and are typically used for the hot, impact face. The one or more grids are placed at successively increasing distances from the interior wall of the vessel, before or during formation of the thermal insulation on the interior surface of the vessel. In one embodiment, one or more erosion detecting grids of the invention may be contained in a replaceable section of insulation placed against the inner surface of the vessel wall, or at a specified distance inwardly of the wall, either before, as, or after the insulation layer(s) have been formed or placed in the vessel. This enables facile placement and replacement of the erosion detecting grids during a maintenance turn-around. This is explained in detail below and with reference to the figures.

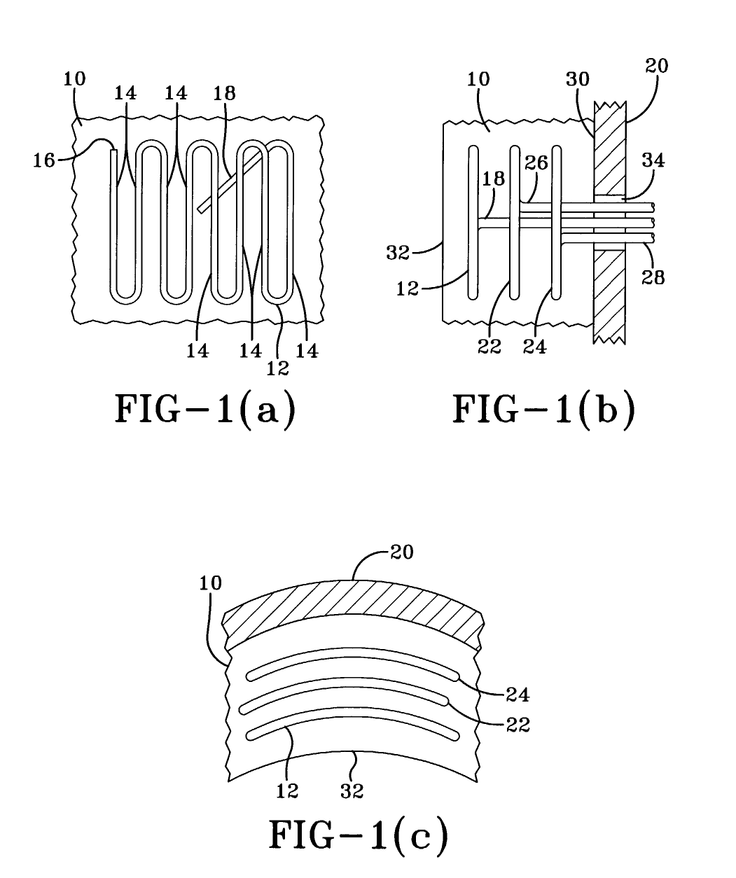

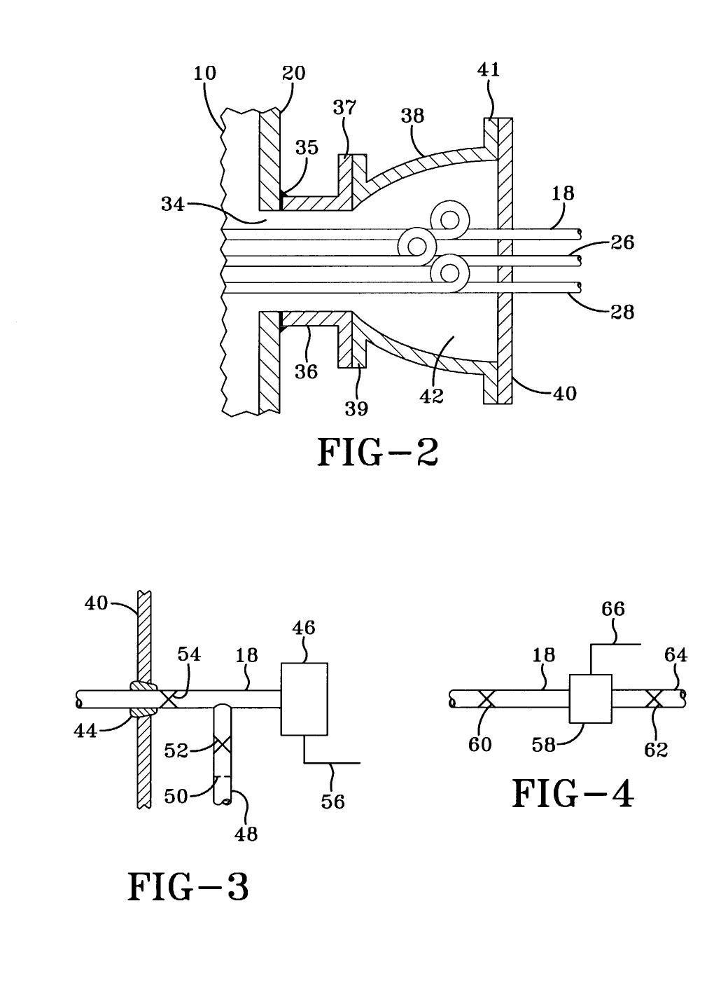

FIGS. 1(a), 1(b) and 1(c) respectively illustrate brief schematic cross-sectional front, side and top views of a section of thermal insulation in a metal vessel. Referring to FIG. 1(a), a section of refractory thermal insulation 10 is shown containing a grid 12 within. The grid comprises a single hollow conduit bent into the form of a series of elongated parallel sections 14. The single conduit from which the grid is formed is hermetically sealed at one end 16 and terminates at the other end in a leg 18, for connecting the grid to a pressure sensing means external of the vessel. For the sake of brevity, in this illustration only eight parallel sections are shown. If desired, a grid comprising two parallel or perpendicular arranged arrays, such as in the form a lattice or screen could also be used, with all the arrays terminating at one end in a single conduit leg that passes through the vessel wall. FIG. 1(b) shows two additional grids 22 and 24 identical to grid 12, disposed in the thermal insulation under grid 12. All three grids contain a gas maintained at a pressure different from, and typically higher than, the pressure inside the vessel. The conduit is made of a soft stainless steel, able to withstand the temperature inside the insulation in the vessel without melting and which will erode when the insulation is eroded down to it. This changes the pressure in the grid and this pressure change is detected by any suitable means, such as a pressure transducer, piezoelectric device and the like, external of the vessel and with which the conduit is in fluid communication. The detecting means may then send out an electrical signal (e.g., P/I or P/V) indicative of the change. Such means are shown in FIGS. 3 and 4 as respective boxes 46 and 58, which send an electrical signal to monitoring means external of the vessel, to indicate that erosion of the thermal insulation has progressed to the depth of that particular grid. Turning now to FIG. 1 (b), there is schematically depicted a vertical cross-section of a portion of the thermally insulated steel wall 20 of a process vessel or furnace. The three identical grids 12, 22 and 24, are shown disposed over each other in the insulation 10 and spaced apart at successively increasing distances from the inner surface 30 of the steel vessel wall, towards the hot face 32. Not shown are the metal anchors fastened to the inner wall of the vessel, for holding the thermal insulation in place. By way of an illustrative, but nonlimiting example, the steel vessel wall may be 1 to 2 inches thick and the thermal insulation may be 8 inches thick. Grids 12, 22 and 24 are fabricated of one-half inch stainless steel tubing, imbedded in the insulation over each other at respective distances of 2, 4 and 6 inches from hot face 32. This enables monitoring the erosion progress over a period of time, so that process conditions can be changed to slow the erosion rate and schedule a maintenance turn-around, in which the vessel is taken off line for replacement of the insulation. One end, 18, 26 and 28, of each respective grid conduit is the leg or conduit which passes through a single hole 34 in the steel wall 20 and then through a single nozzle (shown as 36-38 in FIG. 2) exterior of the vessel, where each is connected to a source of constant pressure gas and means for detecting a pressure change in its respective grid. This is shown in FIGS. 3 and 4. Referring to FIG. 1(c), although not shown, grids 22 and 24 are identical to grid 12. The three grids are disposed a plane parallel to each other and to hot face 32, as shown. In one embodiment (not shown) of the FIG. 1(c) configuration, grid 22 is slightly laterally offset, so that the orientation of the three grids is slightly staggered. This staggered type of arrangement with respect to the grid arrays offers additional lateral area coverage, without having to have as high a tube density. In another embodiment (not shown) grid 22 could be larger in planar cross-sectional area than the other two, so as to provide as staggered effect without compromising on overall area coverage. In another embodiment (not shown) of the FIG. 1(c) configuration, the grids are also oriented so that the parallel conduit array of one grid is perpendicular to the orientation of those grids adjacent each side. In such an arrangement and with respect to FIG. 1(c), the parallel array of conduit lengths of grids 12 and 24 will be the same, but with the orientation of the parallel conduit lengths making up grid 22 perpendicular to those in grids 12 and 24. Irrespective of the design and arrangement of the grids, the overall area coverage of the grid array should be dense enough to minimize the chances of a hole being eroded to the vessel, wall without eroding open a hole in at least one grid, yet not so dense so as to unduly reduce thermal insulation and erosion-resistance. FIG. 1(c) is a brief schematic top view of FIG. 1(a) and, like FIG. 1(b), shows the three grids 12, 22 and 24 disposed in the insulation 10. In this embodiment, the vessel wall is curved, as shown. The plane of the hot face 32 of the insulation and of the three grids 12, 22 and 24, are all parallel to each other and to the plane of the vessel wall 20. Not shown in FIG. 1(c) for simplicity are the connecting legs of the grids and the opening through wall 20. Other illustrative, but nonlimiting embodiments include, for example, a ladder-like grid and a grid somewhat like a double-sided comb or a yagi antenna, in which a series of parallel and spaced apart conduits in the same plane extend perpendicularly out in opposite directions from a central conduit, with which they are in fluid communication, and with each embodiment having a single leg passing from the grid to or through the vessel wall.

FIG. 2 is a simple partial perspective of a portion of a vessel wall 20 and insulation 10, with the three grid connecting legs or conduits 18, 26 and 28 passing through a nozzle 36, a nozzle expansion extension 38 and a blind flange 40, exterior of the vessel. Although not shown in FIG. 2, each grid leg is pneumatically connected to a separate sensing means, such as a pressure transducer, for sending out an electrical signal indicative of a pressure change in that grid, to the external monitoring means. Two examples of such means are shown in FIGS. 3 and 4. Nozzle 36 is attached to the wall 20 by welding or any other suitable means. Expansion extension 38 provides room for each grid leg to each have an expansion loop, as shown. Flanges 37 and 39 connect 36 and 38, and both are filled with thermal insulation. The three legs are each sealed in the blind flange by means of pressure fittings indicated at 44 in FIG. 3. Each of the three legs 18, 26 and 28 are connected to separate, respective means for sensing a change in pressure in a respective grid, as illustrated for example, in FIGS. 3 and 4. Thus, turning to the embodiment of FIG. 3, grid leg 18 is connected to a pressure transducer 46. A pressure regulated gas supply line 48 maintains a predetermined gas pressure in grid 12, via leg 18. A restriction orifice 50 limits the amount of gas that can enter the vessel in the event of an opening eroding in grid 12, until valve 52 can be closed. Another valve 54 is a shutoff valve to isolate the grid. Either or both valves 52 and 54 can be manually and/or automatically actuated by a predetermined pressure change in the grid. In the event of erosion through any portion of the grid, pressure transducer 46 detects a change in the pressure in line 18 and sends an electrical signal indicative of the change, over electric line 56. The signal is sent, via line 56, to suitable alarm, indicating and/or control means including, for example, an alarm, a recorder, a computer and means for automatically making adjustments to the process or shutting it down. FIG. 4 is an alternate arrangement in which the regulated gas supply passes through the pressure transducer 58. Valves 60 and 62 function similarly to valves 54 and 52. Electric line 66 functions in a manner similar to line 56.

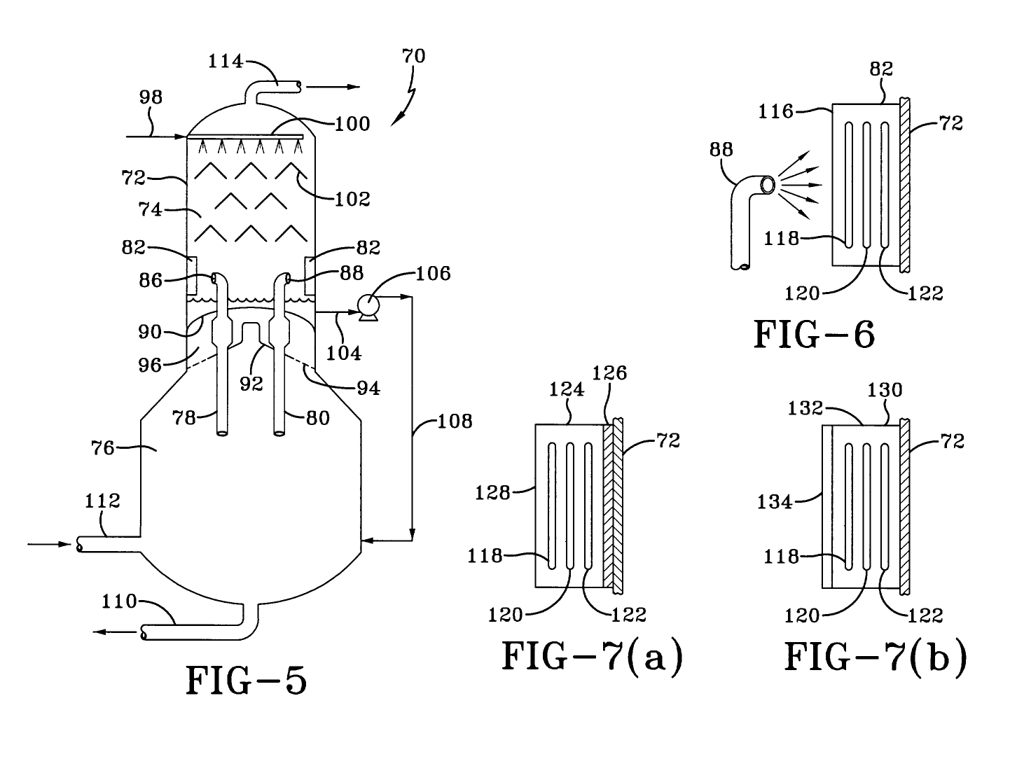

FIG. 5 is a simple cross-sectional schematic of a coker vessel which includes a scrubber. Thus coker 70 comprises a generally cylindrical vessel 72, which includes a scrubbing section 74 disposed over a coking section 76. These two sections are connected by a plurality of cyclones, of which only two, 78 and 80 are shown. Cyclones 78 and 80 each direct a hot stream, comprising hydrocarbon vapors and fine coke particles produced by the cracking reaction in 76, up into the scrubber section 74, via cyclone discharge nozzles (sometimes referred to as snouts) 86 and 88. The cyclones extend up from 76 into 74, via openings in an otherwise gas and liquid impermeable separating plate 90. A ring-shaped ceramic shield 82 is disposed against the interior wall of the vessel wall in the scrubber section 74, to prevent erosion of the vessel wall by the hot gas and particles discharged by the cyclone nozzles. Anticoking baffle 92 is permeable to gas and liquid around its periphery, as indicated by the dashed lines 94, and space 96, which contains ceramic or metal packing (not shown). The packing serves as thermal insulation between the coking and scrubbing sections. The coking vessel typically operates at about 800° F. and thermal insulation over the vessel wall is not required. However, shield 82 is required to prevent the hot discharge from the cyclones from eroding through the vessel wall opposite the nozzle openings. Thus, the ceramic shield must be resistant to erosion from the hot, coke particle-containing gas stream impinging on it. These nozzles and the cyclone discharge conduits feeding them can become partially clogged, and may also have uneven wear. This causes the discharge from the nozzle to be uneven. Therefore, the shield has to be large enough in its vertical dimension protect the vessel wall from impingement over an area greater than that normally expected from the discharge nozzles. In one actual installation, the shield is about five feet high. In operation, the heavy coker feed is passed, via feed line 98 into the top of the vessel, from where it is distributed downwardly by a plurality of spray means 100. The distributed feed oil flows down through the scrubber section 74, which contains a plurality of baffles 102 known as sheds. As the feed oil flows down, it contacts the hot oil vapors and coke particles rising up from the cyclone discharges. The hot vapors rising up through the scrubber from the snout outlets contact the liquid feed flowing down. Lighter material in the feed is stripped out and is carried overhead with the vapor into the next vessel. Heavy components in the feed stream continue down through the scrubber and end up in the pool above plate 90. This liquid that collects on top of plate 90 comprises the coker feed which is withdrawn via line 104 and passed, via pump 106 and line 108, down into the coking and cracking section 76. In 76 the heavy liquid hydrocarbons contact hot (e.g., ˜1100° F.) coke particles which thermally crack a portion of the heavy, 700° F.+ feed oil into lower boiling hydrocarbons and coke particles. The coke particles are withdrawn from the bottom of the coker via line 110 and passed to a regenerator (not shown) in which they are partially combusted to heat them up. The resulting hot coke particles are then fed back into the coker via line 122. The cracked and vaporized hydrocarbons boiling below about 350° F. pass up through the cyclones and scrubbing section and out the top of the coker via line 114, which passes them to further processing.

As mentioned above, the cyclone nozzles discharge into the scrubber in a direction in which the particles would impinge against the coker vessel wall, but for the protective shield 82 disposed between the flowing particles and the wall. These shields are preferably harder than typical refractory metal oxide thermal insulation used to line the walls of furnaces and process vessels, to be able to withstand the constant impingement and scouring by the hot coke particles. FIG. 6 is a brief schematic, partial side view illustrating a coker nozzle 88, discharging a hot mixture of hydrocarbon vapors and coke particles indicated by the arrows, against a protective ceramic shield 82, disposed against the wall of vessel 72. For the sake of illustration, ceramic shield 82 is five feet high and, at each location opposite the discharge nozzle exits, has disposed in it three pneumatic grids, 118, 120 and 122. These grids are all of a shape and disposition similar to that illustrated in FIG. 1 and each has an area of slightly less than 5″×5″, parallel to the impact face 116. Not shown for the sake of brevity, are means for anchoring the shield to the vessel wall, the nozzle and legs through the wall, etc. Other illustrative, but nonlimiting embodiments of an erosion shield containing grids according to the invention are illustrated in FIGS. 7(a) and 7(b). In FIG. 7(a), a shield 124 comprises a composite of a hard, abrasion resistant refractory oxide ceramic 124, disposed on a metal backing plate 126. Three grids 118, 120 and 122 are disposed in the ceramic as in the case of FIG. 6. In this embodiment, the metal backing plate 126 of the shield 124 is fastened to the vessel wall. This provides greater resistance to cracking and breaking the integrity of the ceramic during transporting, handling and installation onto the vessel wall. Yet an other embodiment is shown in FIG. 7(b), in which the shield 130 comprises a composite of (i) a very hard and erosion resistant, sintered ceramic inner shield 134, disposed over and onto (ii) more conventional, less dense and less erosion resistant thermal insulation 132. This permits the use of a very hard sintered ceramic in combination with a less hard ceramic that, if it is sintered, is not sintered at a temperature high enough to collapse or melt of any grids disposed in it. In yet another embodiment, the composite shield of FIG. 7(b) may also include a metal backing plate, as in FIG. 7(a).

What is claimed is:

1. A method for detecting erosion of a ceramic shield or thermal insulation having an impact or hot face exposed to a hot environment, comprises monitoring the pressure in at least one relatively planar, wide area erosion detecting grid, the plane of which extends over an area of at least one square foot and substantially follows the contour of said impact or hot face of said shield or insulation in or under which it is disposed, that is subject to erosion, wherein said grid comprises at least one hollow fluid conduit in which a fluid is maintained at a predetermined pressure, until erosion reaches said grid and erodes an opening in it, which changes said pressure, and wherein said pressure change is detected.

2. A method according to claim 1 wherein said grid comprises a plurality of substantially parallel sections of conduit arrayed in the plane of said grid.

3. A method according to claim 2 wherein said hot environment comprises the interior of a vessel.

4. A method according to claim 3 wherein a single conduit, in fluid communication with said grid, extends from it to or through a hole in said vessel and to a nozzle exterior of said vessel.

5. A method according to claim 4 wherein said grid extends over an area of at least two square feet.

6. A method according to claim 5 wherein said fluid comprises a gas.

7. A method according to claim 6 wherein said area comprises at least four square feet.

8. A method according to claim 7 wherein said at least one grid is disposed in said shield or insulation.

9. A method according to claim 8 wherein said vessel comprises a coker and said at least one grid detects erosion of a shield therein.

10. A method for detecting and monitoring the erosion of a ceramic shield or thermal insulation having an impact or hot face exposed to a hot environment and in which is disposed at least two, relatively planar, wide area pneumatic erosion detecting grids, the planes of which are substantially parallel, extend over an area of at least one square foot and substantially follow the contour of said impact or hot face where it is subject to erosion, with said grids being spaced apart and located at successively greater distances from said hot or impact face, comprises monitoring the pressure in each of said grids, wherein each said grid comprises at least one hollow fluid conduit in which a fluid is maintained at a predetermined pressure, until erosion reaches each it and erodes an opening in it, which changes said pressure, and wherein said pressure change is detected.

11. A method according to claim 10 wherein each said grid comprises a plurality of substantially parallel sections of conduit arrayed in the plane of said grid.

12. A method according to claim 11 wherein said hot environment comprises the interior of a vessel.

13. A method according to claim 12 wherein said plane of each said grid extends over an area of at least two square feet.

14. A method according to claim 13 wherein a single conduit depends from each said grid, with which it is in fluid communication, and extends from each said grid to or through a hole in said vessel.

15. A method according to claim 14 wherein each said single conduit extends through a hole in said vessel and to a nozzle exterior of it.

16. A method according to claim 15 wherein said fluid comprises a gas.

17. A method according to claim 16 wherein said area comprises at least four square feet.

18. A method according to claim 17 wherein said vessel comprises a coker and said grids detect erosion of a shield therein.

19. A method according to claim 18 wherein said shield is positioned adjacent to at least a portion of an interior wall surface of said vessel.
